(19) United States
(12) Patent Application Publication
(10) Pub. No.: US 2017/0156526 A1
(43) Pub. Date: Jun. 8, 2017

(54) Disposable Relish Spoon

(71) Applicant: Dorothy Swanson, Lake Wales, FL (US)

(72) Inventor: Dorothy Swanson, Lake Wales, FL (US)

(21) Appl. No.: 14/960,398

(22) Filed: Dec. 6, 2015

(51) Int. Cl. A47G 21/04; A47J 43/28

(52) U.S. Cl. CPC A47G 21/04; A47J 43/284

(57) ABSTRACT

An improved culinary spoon is disclosed. It may be used as an ordinary cooking spoon or as a utensil for removing vegetables and other small food condiments from a jar containing liquid in such a manner that the small solids will remain upon the bowl of the spoon while the liquid will drain through the bowl of the spoon. Thereby, food condiments are easily removed from the jars without the liquids in which they are immersed.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

Field of the Invention

The present invention relates to tableware and daily necessities, especially kitchen supplies. This invention specifically relates to a spoon with drain holes. This invention is used for removing food from containers, particularly deep containers that have relatively narrow openings, such as jars or the like.

Background of the Invention

There are numerous utensils presently available for removing food from containers, but they have been found to be inconvenient to use in many instances. They are particularly impractical for removing relishes and other foods that are immersed in a liquid that is contained in relatively deep containers that have narrow openings. For example, the implements generally provided for removing olives, pickles, and the like from jars consist of an elongated handle with a plurality of tines extending from one end for the purpose of piercing the food item to secure it and raise it from the jar to mar it, detracting from its appearance. Furthermore, this method of grasping the food is not positive, and frequently it will accidentally fall from the tines before it is brought to the serving dish or receptacle in which it is to be placed. When this does not occur, the food must be manipulated to release it from the tines.

In those instances where the piercing of food is not practical, it has been the practice to employ spoons with elongated handles for reaching into the jar to remove the food. Such implements have the spoon portion substantially in alignment with the handle in the usual manner so that it is necessary to tilt the jar to enable the spoon to be held in a substantially horizontal position for receiving and retaining the food. In order to tilt the jar in this manner, it is necessary to remove a portion of the liquid to avoid spilling it. If all of the food is not served immediately, some of it remaining in the jar may then not be covered by the liquid, and its spoilage will therefore be accelerated. For example, capers are pickled in a liquid and marketed in sealed jars. These are too small to be conveniently pierced by tines, and the entire jar is not usually consumed at one serving. For their preservation in the unsealed jar, it is desirable that those remaining be immersed in the pickling fluid. However, it is inconvenient to extract them from the jar with ordinary spoons without removing an excessive amount of the liquid. For these reasons, the implements presently available for removing these types of food from containers have been found to be not entirely satisfactory for general use.

The prior art reveals patents that have attempted to address this issue. U.S. Pat. No. 1,334,169 A “Culinary spoon,” to Royer, provides a device that may be used as an ordinary cooking spoon or as a utensil for dipping vegetables and the like from a cooking utensil that contains liquid in such a manner that the vegetables will remain on the bowl of the spoon, while the liquid will drain through the bowl or the spoon into the receptacle. Furthermore, US 20010045388 A1 “Soup ladle structure,” to Lung-Ho, discloses a soup ladle structure that scoops up either only the floating fat scum on the surface of the broth, or only the solid food, without removing the delicious broth. '388 patent discloses an elastic element inserted and axially conjoined to the handle bodies of the soup ladle and the stop straining plate by means of an axle pin for always maintaining a cover body covering closely on the strainer pore of the soup ladle, while the press handle on the upper end of the stop straining plate makes the cover plate on the lower end lift to open or close tightly on the strainer pore by the axially engaged point and the elastic element. This achieve the purposes of either straining the liquid while leaving the fat for scooping up and removing the floating fat of the broth, or only picking up the solid food. Similarly, U.S. Pat. No. 2,923,059 A “Draining spoon,” to Louis Campagna, discloses a spoon that will readily and effectively separate solids from liquids, such as seeds from oranges or grapefruits, pulp from tomatoes, or the like. That is done by allowing the juice to pass through and under the spoon with relatively greater freedom from clogging them with ordinary spoons.

Thus, there has long been a need for devices that easily drain small food items from jars without any extra effort or fuss. However, there has not heretofore been an available device that is a disposable spoon with multiple holes used as drainage holes for convenient handling of small food condiments from jars, such as capers, relish, etc.

While these devices fulfill their respective, particular objectives and requirements, the aforementioned patents do not disclose a system that can be used with multiple sizes of jars and food condiments. What is needed is a system or method that solves one or more of the problems described herein and/or one or more problems that may come to the attention of one skilled in the art upon becoming familiar with this specification.

To address these problems, a spoon with drainage holes has been designed. Accordingly, there remains a need for a culinary device for conveniently removing small food items or condiments from jars of cocktail onions, olives, relishes, capers, etc.

### SUMMARY

In view of the foregoing disadvantages inherent in the known types of disposable relish spoons present in the prior art, the present invention provides an improved system for removing small food condiments from jars that can easily be used with all types of jars with food condiments. As such, the general purpose of the present invention, which will be described subsequently in greater detail, is to provide a new and improved system for removing small food condiments from the jars that has all the advantages of the prior art, and none of the disadvantages.

Accordingly, it is a primary objective of the present invention to provide a spoon with drain holes to easily drain small food items from jars, such as relish, capers, pimentos, cocktail onions, etc. The present invention is a reusable yet disposable teaspoon with multiple drainage holes.

It is, therefore, a general purpose of the present invention to provide an improved culinary utensil for removing food from containers.

Another objective of the present invention is to provide an improved culinary utensil that is adapted for lifting small food condiments from their container.

Another objective of the present invention is to provide an improved culinary utensil that may be employed to remove food from deep containers without marring the food.

Another objective is to provide an improved utensil that is adapted to scoop food from deep containers without excessively inclining the containers.

A further objective is to provide an improved culinary utensil that is adapted to individually remove a large variety of the various types of foods packaged in relatively deep containers with narrow openings.

A further objective is to provide an improved culinary utensil with multiple drainage holes that are approximately ⅛″ to 7/64″ in diameter.

A further objective is to provide an improved culinary utensil approximately 24 drainage holes that are evenly spaced.

A still further objective is to provide an improved culinary utensil for removing food from containers that is of simple and inexpensive construction but efficient and convenient in operation.

It is still another aspect of the present invention to provide an improved culinary utensil for removing food from containers that may be easily and efficiently manufactured and marketed.

With the above and other objectives in view, the invention resides in combination and arrangement of parts and in the details of construction hereinafter described and claimed. It should be understood that, within the scope of what is claimed, changes in the precise embodiment of the invention shown can be made without departing from the spirit of the invention.

Other aspects of the present invention will become apparent, from time to time, throughout the specification, as hereinafter related.

There has thus been outlined, rather broadly, the more important features of the invention in order that the detailed description thereof that follows may be better understood, and in order that the present contribution to the art may be better appreciated.

Numerous objectives, features, and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments, and of being practiced and carried out in various ways. Also, it is to be understood that the phraseology and terminology employed herein are for the purpose of description, and should not be regarded as limiting.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is therefore, not to be considered limiting of its scope. The invention will be described and explained with additional specificity and detail through the use of the accompanying drawing, in which:

FIG. 1 depicts an improved culinary utensil for removing food from containers

### DETAILED DESCRIPTION OF THE INVENTION

The embodiments of the present disclosure, described below, are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawing, which are incorporated into and form part of this disclosure, illustrate embodiments of the invention, and, together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed, and the subject invention is intended to include all such aspects and their equivalents. Other advantages and novel features of the invention will become apparent from the following detailed description of the invention when considered in conjunction with the drawings.

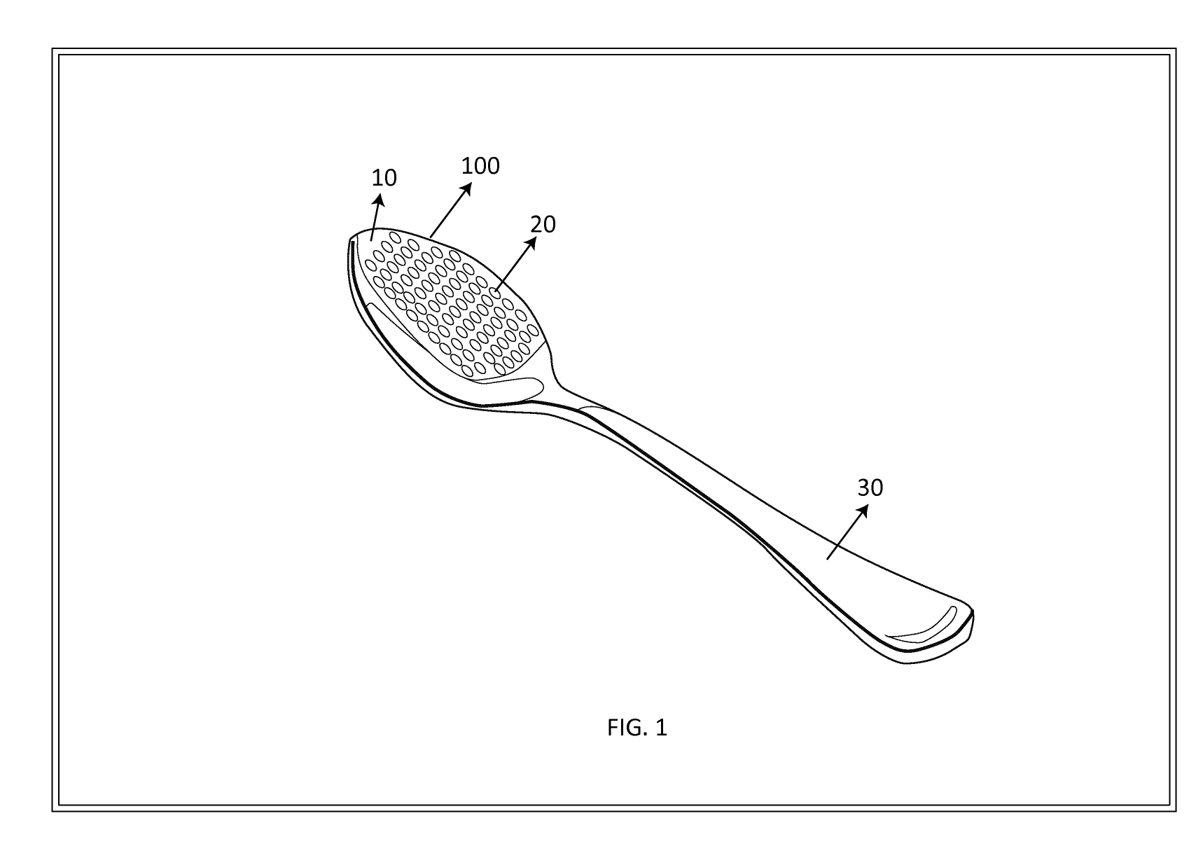

The present invention FIG. 1 provides an improved culinary utensil for removing food from containers. It is essentially a handle (30) with an elongated shank extending co-axially therefrom, with a spoon (100) portion formed integrally at the opposite end of the shank. The spoon (100) portion presents the usual concave surface for receiving and retaining food, but this surface is provided with openings in the form of holes (20) to permit the drainage of liquid so that the food item may be conveniently removed from its container without including a portion of the liquid in which it is immersed. The shape of the spoon includes regular shapes, such as elliptical, oval, circular, and shapes thereof.

The spoon includes a spoon body with spoon head and handle, which is characterized by: evenly spaced drain holes that are approximately ⅛″ to 7/64″ in diameter.

By adopting the above arrangement, liquids, such as soup, will leak out from the holes while the solid matter will be retained. The invention is convenient for removing small pieces of food condiments from a jar of food products, such as relish, capers, pimentos, cocktail onions, etc. The present invention is a reusable yet disposable teaspoon with multiple drainage holes.

The foregoing and other objectives of the invention, which will become apparent from the following detailed specification setting forth an illustrative embodiment, may be achieved by the particular construction depicted in and described in connection with the accompanying drawings, in which the present invention relates to an improved culinary spoon that may be used as an ordinary cooking spoon or as a utensil for dipping vegetables and the like from a cooking utensil containing liquid or the like in such a manner that the vegetables will remain upon the bowl of the spoon while the liquid will drain through the bowl of the spoon into the receptacle.

Accordingly, the improved culinary utensil of the invention is advantageous for removing food from containers without the liquid part of the food product. The spoon removes food from deep containers without marring the food, and is adapted to scoop food from deep containers without excessively inclining containers that are relatively deep with narrow openings. This further ensures that other parts of the recipes, such as the hot dog or the bun, are not made soggy due to excessive juices. Furthermore, a messy situation is avoided due to this.

In a preferred embodiment of the invention, the spoon has a bowled area with a base and an elongated handle (30) attached to the bowled area (10), with the handle (30) having a uniform rectangular profile. A plurality of holes (20) are provided in the base of the bowled area (10) adjacent to the handle (30) for performing the straining function. Furthermore, the holes (20) are approximately 24 in number such that all of the holes are evenly spaced. Furthermore, the spoon (100) has multiple drainage holes (20) approximately ⅛″ to 7/64″ in diameter. The spoon is made of plastic and is disposable.

It is to be understood that the above description is intended to be illustrative, and not restrictive. For example, the above-discussed embodiments may be used in combination with each other. Many other embodiments will be apparent to those of skill in the art upon reviewing the above description.

With respect to the above description, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Furthermore, since numerous modifications and changes will readily occur to those skilled in the art, it is not desired to limit the invention to the exact construction and operation shown and described. Accordingly, all suitable modifications and equivalents may be resorted to, falling within the scope of the invention.

I/We claim:

1. An improved culinary utensil for removing food from containers, comprising:
a bowled area having a base;
a handle attached to said bowled area; and
a plurality of holes provided in the base of the bowl adjacent the handle area wherein, said handle having an elongated shank extending co-axially therefrom with a spoon portion formed integrally at the opposite end of the shank.

2. An improved culinary utensil as claimed in claim 1, wherein the spoon portion presents the usual concave surface for receiving and retaining food.

3. An improved culinary utensil as claimed in claim 1, wherein said holes permit the drainage of liquid so that the food item may be conveniently removed from its container without including a portion of the liquid in which it is immersed.

4. An improved culinary utensil as claimed in claim 1, wherein the shape of said spoon portion is elliptical.

5. An improved culinary utensil as claimed in claim 1, wherein said handle has a uniform rectangular profile.

6. An improved culinary utensil as claimed in claim 1, wherein said plurality of holes is at least 24 in number.

7. An improved culinary utensil as claimed in claim 1, wherein said plurality of holes are evenly spaced.

8. An improved culinary utensil as claimed in claim 1, wherein said plurality of holes are of diameter at least ⅛″.

9. An improved culinary utensil as claimed in claim 1, wherein said plurality of holes are of maximum diameter 7/64″.

10. An improved culinary utensil as claimed in claim 1, wherein said spoon is disposable.

11. An improved culinary utensil as claimed in claim 1, wherein said spoon is made of plastic.
